(19) United States
(12) Patent Application Publication
(10) Pub. No.: US 2001/0049628 A1
(43) Pub. Date: Dec. 6, 2001

(54) On-line system for aggregation of purchase bonuses

(76) Inventor: Robert Icho, San Mateo, CA (US)

Correspondence Address: Harris Zimmerman, Law Offices of Harris Zimmerman, 1330 Broadway, Suite 710, Oakland, CA, 94612-2506, US

(21) Appl. No.: 09/815,838

(22) Filed: Mar. 22, 2001

Related U.S. Application Data
(60) Provisional application No. 60/191,696, filed on Mar. 23, 2000.

(51) Int. Cl. G06F 17/60

(52) U.S. Cl. 705/14; 705/26

(57) ABSTRACT

A purchase award program for purchases through the internet includes a web site having a mail server, database server, and web server. Users register with the system, and the user's name and email address are stored in the database server. To initiate a purchase or browse commercial web sites, the user first enters the program web site, receives verification, and is directed to a web page displaying a list of vendors related to any selected category. When the user purchases from a vendor's web site, the procedure is carried out as required by the vendor, and the program receives the purchase information such as: order number, amount purchased and the time of the order. The order information is stored in the database server and the user's account is updated with purchase award points. Periodically, the database server requests to purchase points from a points supplier corresponding to users' purchases. The user may convert accumulated points for purchases, such as frequent flyer miles to purchase airline tickets.

### REFERENCE TO RELATED APPLICATION

This application claims priority based on Provisional Application No. 60/191,696, filed Mar. 23, 2000.

### BACKGROUND OF THE INVENTION

One of the most effective and popular devices for attracting customers and maintaining customer interest is the benefit award program that rewards purchases with credits that may be converted to free goods and services. Such programs were innovated by airlines offering free airline tickets in return for a specified number of flights or, more often, the summed number of miles flown by a customer on an air carrier. Because of the success of frequent flyer miles programs, benefit awards have been adopted by many credit card issuers, in alliances with airlines as well as other purveyors of travel services, goods, and services.

These alliances are limiting factors for customers wishing to garner purchase awards for conversion into free goods or services. Typically an air carrier will provide free flight coupons only in response to a minimum number of miles flown on its own aircraft, and those coupons are useful only for that one airline. (Some airlines have entered into agreements with overseas air carriers to expand the scope and attractiveness of their frequent flyer programs.) Likewise, credit card companies that offer frequent flyer miles in exchange for purchases transacted with their issued credit cards typically limit redemption of the frequent flyer reward to one airline. These factors may not serve the customer optimally, due to the fact that most air carriers focus their service to their most popular and profitable routes, and provide minimal service or no service on other air traffic routes.

The rise of the internet as a commercial medium has enabled any purchaser with an internet-capable device to shop and buy goods and services all over the globe. The juxtaposition of the limitless internet buying capability and the rather limited purchase award programs now being offered provides a powerful indication of the need in the prior art to improve purchase award programs for the oncoming wave on internet commercial activity.

### SUMMARY OF THE INVENTION

The present invention generally comprises a system and method for providing a purchase award program that may be applied to any purchases carried out through the internet.

The system of the invention includes a mail server, a database server, and a web server, all connected to each other and to the internet or any equivalent network that is accessible to the public or to a large customer base. These server systems may be disposed at a single location or may be distributed in disparate locations. These servers form a web site for the purchase award program, which is termed herein Milesmall, in recognition of the awarding of frequent flyer miles in response to purchases made through the system of the invention. However, the system may be titled or denominated with any convenient or suitable name, and the use of Milesmall is not considered a limitation of the system.

The method of the invention includes a initial sign-up step, in which a potential user contacts the Milesmall web site through the internet, and requests to register with the system as a customer, and to be awarded purchase award points or units, such as frequent flyer miles, corresponding to the sum of the purchases made through the system. Upon successful registration, the user is informed that in order to earn purchase award units, the user must access vendor web sites through Milesmall web links, and must use the email address that corresponds to the registration. The user's name and email address are stored in the system database server. Thereafter, any future email messages sent to the user's Milesmall account are first received by the system mail server, and are then logged into the database server, and forwarded to the user's email address.

The mail server may handle all incoming mail, and processes incoming mail for vendor purchase information and marketing advertisements. It then forwards the mail back to the address of the intended recipient, and copies of email classified as marketing are sent to the designated marketing person. All Milesmall.com accounts double as mail forwarding accounts to real email addresses, so whenever mail comes in, it also goes back out.

The web server stores all of the web pages and also handles much of the web interaction between users and Milesmall.com. The web server also transfers control to vendors when users click on vendor links on Milesmall pages. The database server contains all user and vendor information, including user's account information, transaction information, and vendor contact information. Milesmall data is stored on the database server.

To initiate a purchase transaction, or to browse commercial web sites, the user first enters the Milesmall web site, and receives the Milesmall greeting page. The system verifies the user's name and password (this may be carried out transparently as a cookie transaction), and directs the user to proceed with shopping and browsing. The user is then directed to a Milesmall page displaying a list of vendors related to any selected category. The page (or pages) display every relevant vendor with an associated logo and a brief paragraph descriptive of the products available from each vendor. The user's browser is directed to a page with a Milesmall header at the top of the screen, and the vendor's home page is displayed in the body of the browser screen. At this stage, the Milesmall account system records that the user has entered a vendor's site, including the time of click-in, vendor name, and the user's name (or screen ID). The user also provides the Milesmall account name whenever an email address is requested by a vendor web page.

When the user makes a purchase from a vendor's web site, the purchase procedure is carried out as required by the vendor's web site presentation. The vendor emails the user an order confirmation to the user's Milesmall.com email address. The Milesmall.com mail server receives the email and forwards a copy of it to the user's real email account. In the meantime, the Milesmall system parses the email to determine if it can recognize the purchase information such as: order number, amount purchased and the time of the order. The order information is entered into the database server and the user's account is updated.

At a later date, the vendor sends the user confirmation of the shipment and payment. The Milesmall.com mail server forwards the confirmation to the user's real email account. Then the Milesmall system analyzes the email for the delivery information for the specific order, and credits the user's account according to the number of points per dollar spent assigned to the web site. Alternatively, vendors may also send email confirmations of purchases with information that would go directly from the mail system to our database.

A registered user may also login to the Milesmall web server and request viewing the account spending history that is stored in the Milesmall database server. This information may be password protected for privacy considerations.

Periodically, the database server sends requests to purchase points from a points supplier corresponding to users' purchases. The points supplier may be an airline frequent flyer program, a hotel points program, or the like. The request includes the individual accounts involved, the program account number, and the points to be credited respectively. The appropriate points are received and credited to the respective accounts in the Milesmall database server.

The registered user may convert accumulated points in the respective account to purchase goods or services. For example, points may be used as frequent flyer miles to purchase airline tickets. The user requests one or more tickets on a specific flight, and the Milesmall system verifies that there is sufficient points for the transaction, and then contacts a ticketing service to complete the transaction. The points used for the transaction are deducted from the user's account.

### BRIEF DESCRIPTION OF THE DRAWING

FIG. 1 is a block diagram depicting the Milesmall system and a transaction between a user's computer and the Milesmall web server.

FIG. 2 is a block diagram depicting the Milesmall system and a transaction between a user's computer and the Milesmall web server and database server.

FIG. 3 is a block diagram depicting the Milesmall system and the Milesmall web server and database server responding to a user's computer.

FIG. 4 is a block diagram depicting the Milesmall system, and the Milesmall web server and database server responding to a user's computer.

FIG. 5 is a block diagram depicting the Milesmall system, and a transaction emanating from the Milesmall web server through the internet to the user's computer.

FIG. 6 is a block diagram depicting the Milesmall system, and a transaction originating from a user's computer, to the internet, and thence back to the user's computer.

FIG. 7 is a block diagram depicting the Milesmall system, and a transaction directed from the internet to the Milesmall mail server and thence to the user's computer and the Milesmall database server.

FIG. 8 is a block diagram depicting the Milesmall system, and a transaction extending from the internet to the Milesmall mail server and thence to the database server.

FIG. 9 is a block diagram depicting the Milesmall system, and a message exchange between the user's computer and the web server and database server of the system.

FIG. 10 is a block diagram depicting a general message transaction from the user's computer through the internet to the Milesmall web server, and return.

FIG. 11 is a block diagram depicting a general message transaction from the user's computer through the internet to the Milesmall web server and database server, and return.

FIG. 12 is a block diagram depicting the steps in a commission sponsor purchase transaction using the Milesmall system.

FIG. 13 is a block diagram depicting a general message transaction from a user's computer through the internet to a vendor's web site, and return.

FIG. 14 is a block diagram depicting the steps in a general purchase transaction through the Milesmall system.

FIG. 15 is a block diagram depicting the steps in crediting a user's account for a purchase at a vendor's web site.

FIG. 16 is a block diagram depicting a transaction between the Milesmall system and a commission sponsor.

FIG. 17 is a block diagram depicting a transaction between the Milesmall system and a points supplier.

FIG. 18 is a block diagram depicting a direct purchase transaction between a user's computer and a web vendor, and the subsequent awarding of purchase points.

FIG. 19 is a block diagram depicting the steps involved in a user redeeming purchase points for a ticket for travel service.

### DESCRIPTION OF THE PREFERRED EMBODIMENT

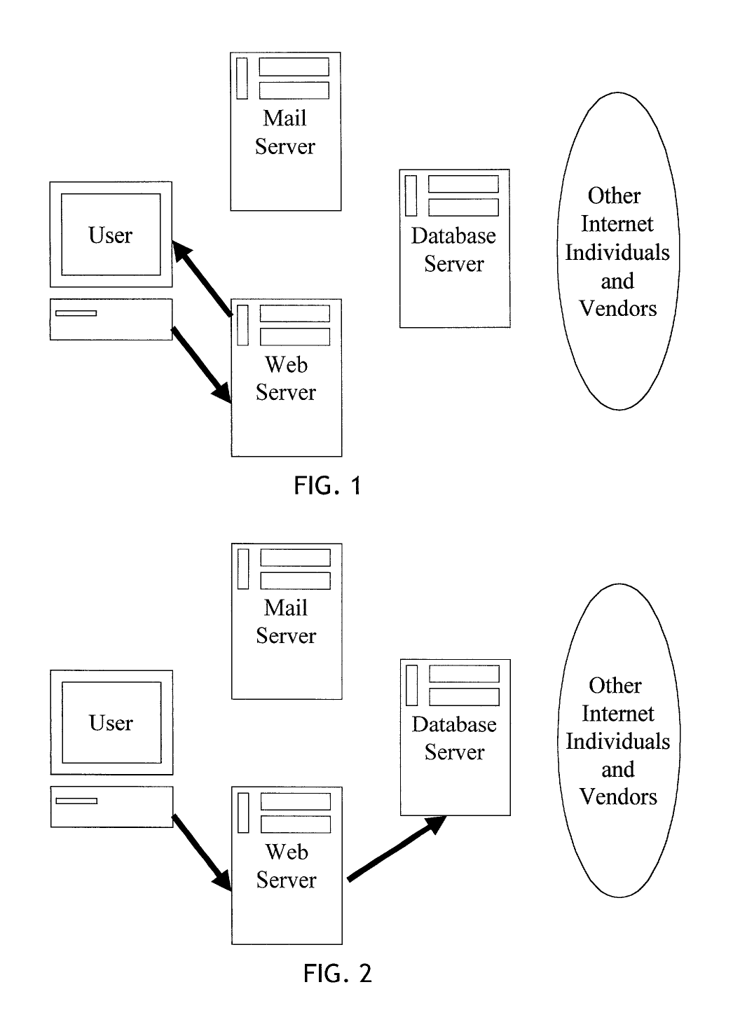

The present invention generally comprises a system and method for providing a purchase award program that may be applied to any purchases carried out through the internet. With regard to FIG. 1, the system of the invention includes the three servers depicted: the mail server, the web server, and the database server, all connected to each other and to the internet or any equivalent network that is accessible to the public or to a large customer base. These servers form a web site for the purchase award incentive program, which is termed herein Milesmall. However, the system may be titled or denominated with any convenient or suitable name, and the use of Milesmall is not considered a limitation of the system. The user's machine may comprise any computer or other digital appliance capable of exchanging messages with the internet, and may also comprise any ISP that the user employs to connect to the Internet, including his/her email services. The oval represents any other entity on the Internet.

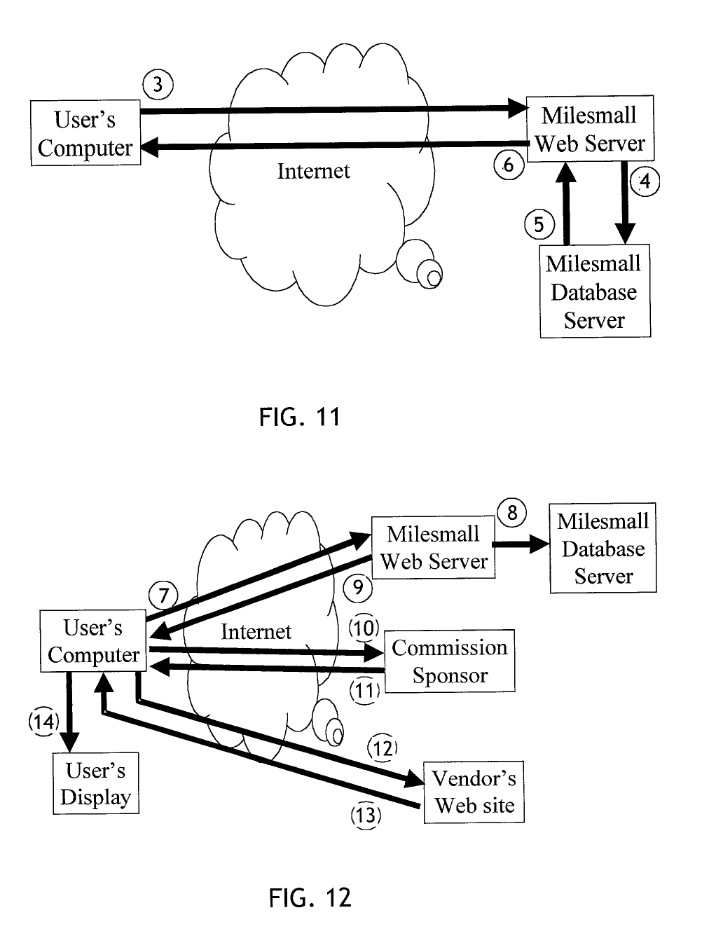

The Milesmall system is available to any user having access to the internet, through a computer, a wireless web-capable device, or any similar digital appliance. A potential user must first register with the Milesmall system, which is undertaken by accessing the Milesmall web page, as shown in FIG. 1. The potential user receives a sign-up form to create an account for the user. As shown in FIG. 11, the user sends information 3 required in the sign-up page, and this data 4 is transferred to the database server. When the data is validated, the database server transmits a message 5 to the web server that data storage was successful or not. The web server transmits a message 6 to the user indicating successful registration (or not). Upon successful completion of the form and receipt of the user information requested, the Milesmall system establishes an account for the user. Upon successful registration, the user is informed that in order to earn purchase award units, the user must access vendor web sites through Milesmall web links, and must use the email address that corresponds to the registration. The user's name and email address are stored in the system database server, as shown in FIG. 2. Thereafter, any future email messages sent to the user's Milesmall account are first received by the system mail server, and are then logged into the database server, and forwarded to the user's email address, as shown in FIG. 4.

The mail server may handle all incoming mail, and processes incoming mail for vendor purchase information and marketing advertisements. It then forwards the mail back to the address of the intended recipient, and copies of email classified as marketing are sent to the designated marketing person. All Milesmall.com accounts double as mail forwarding accounts to real email addresses, so whenever mail comes in, it also goes back out.

The web server stores all of the web pages and also handles much of the web interaction between users and Milesmall.com. The web server also transfers control to vendors when users click on vendor links on Milesmall pages. The database server contains all user and vendor information, including user's account information, transaction information, and vendor contact information. Milesmall data is stored on the database server.

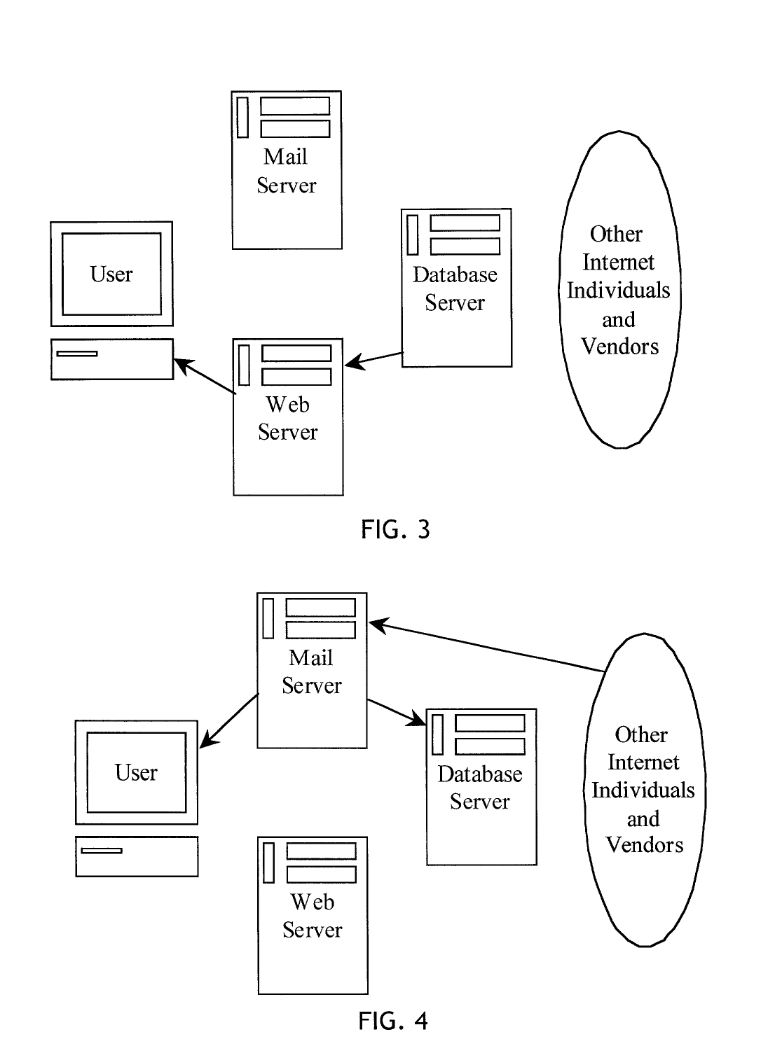

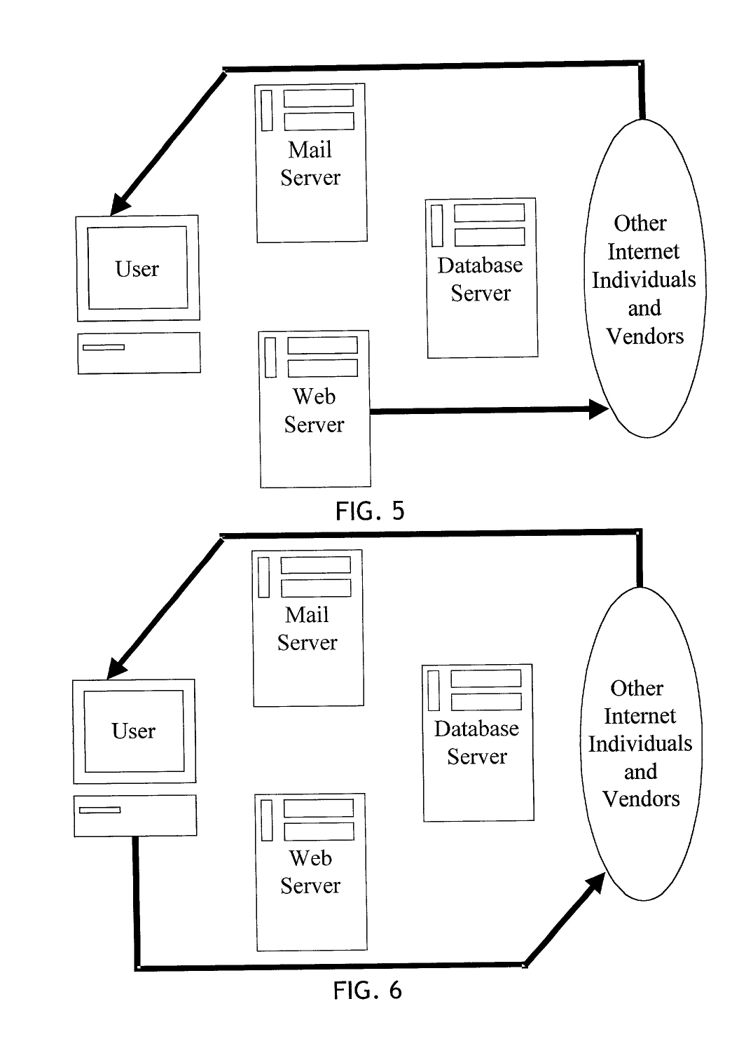

When a registered user wishes to browse commercial web sites, and/or initiate a purchase transaction, the user first enters the Milesmall web site, as shown in FIG. 1, and receives the Milesmall greeting page. This transaction is also shown in FIG. 10, in which message 1 from the user to the Milesmall web site is answered by message 2, which may be the requested web page(s). The web server and database server communicate, as shown in FIG. 2, to verify the user's name and password; if verification is successful, verification is returned to the user (FIG. 3), and the user is then directed to begin browsing and shopping. The user may select a merchandise category or a general shopping course, and user's browser is directed to an appropriate list of vendors related to the category. Screen displays are provided to portray each vendor's logo, a description of the type of products offered, and links to these vendors. The user's browser is directed to a page with a Milesmall header at the top of the screen, and the vendor's home page is displayed in the body of the browser screen. At this stage, as shown in FIG. 2, the Milesmall account system records that the user has entered a vendor's site, including the time of click-in, vendor name, and the user's name (or screen ID). As shown in FIG. 4, the Milesmall web server directs the user's communications to the vendor site, which may then communicate back directly to the user's computer.

With regard to FIG. 12, the steps involved in entering a vendor's site are explained in detail. The user clicks on a vendor link 7 on the Milesmall web site. The web server returns a http redirect command 9 with a real URL referring to either the vendor site or a commission sponsor middleman site. This URL contains imbedded information about the user and that the user got to the vendor site through a link at Milesmall.com. If the URL sent is a commission sponsor middleman site, then the user's computer sends an http request 10 to this middleman site, which also records the fact that the user intends to enter a vendor site that exists on Milesmall.com. The commission sponsor sends back to the user's computer a new http redirect command 11 with the real URL referring to the vendor site. This URL contains imbedded information regarding the user's Milesmall.com account and the fact that this transaction originated from Milesmall.com

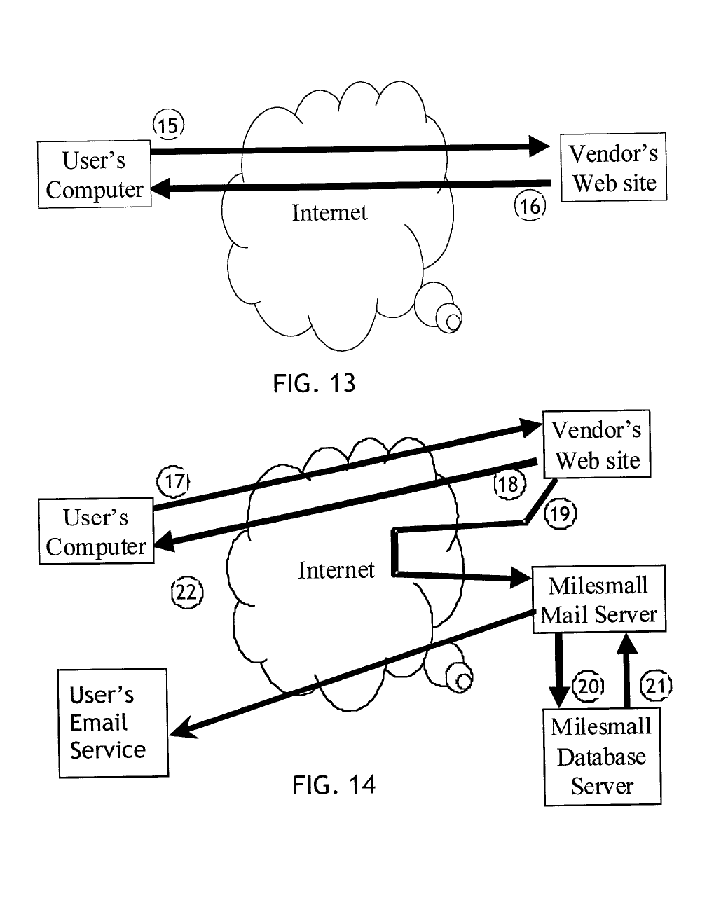

The computer processes the redirect command, causing the computer to access (12) a vendor's web site. The vendor's web site returns its regular page 13 back to the user's computer. The vendor many retain the user's Milesmall.com name and the fact that the transaction originated from Milesmall.com internally. Finally, the vendor's web site appears on the user's display. A record of some or all of this transaction is transmitted by message 8 to the database server. The user then browses the vendor web site, as shown in FIG. 13, exchanging requests 15 and web pages 16.

When the user makes a purchase from a vendor's web site, the purchase procedure is carried out bi-directionally between the user's computer and the vendor, as shown in FIG. 6, and the purchase steps are carried out as required by the vendor's web site presentation. The user provides the Milesmall account name whenever an email address is requested during the purchase routine.

With reference to FIG. 14, the steps in this process include the user entering information (17) in the appropriate forms required by the vendor's web site. The user clicks on any submission buttons. While making the purchase, the user provides his/her Milesmall.com email address. The vendor sends (18) to the user's computer an acknowledgement of the success of the order placement. (This is just the order placement, not an acknowledgement of any delivery, shipment confirmation, or change to the order). If the transaction was successful the vendor sends an email confirmation 19 of the order placement. Because the user provided his Milesmall.com email address, the email actually goes to the Milesmall mail server.

The Milesmall.com mail server sends (20) a copy of the mail to the Milesmall database server. Any purchase information in the email gets stored into the database, and the real email address corresponding to the Milesmall address used is sent back (21) to the Milesmall mail server. The original mail is relayed (22) to the real email address. The user can retrieve this mail using his/her email service.

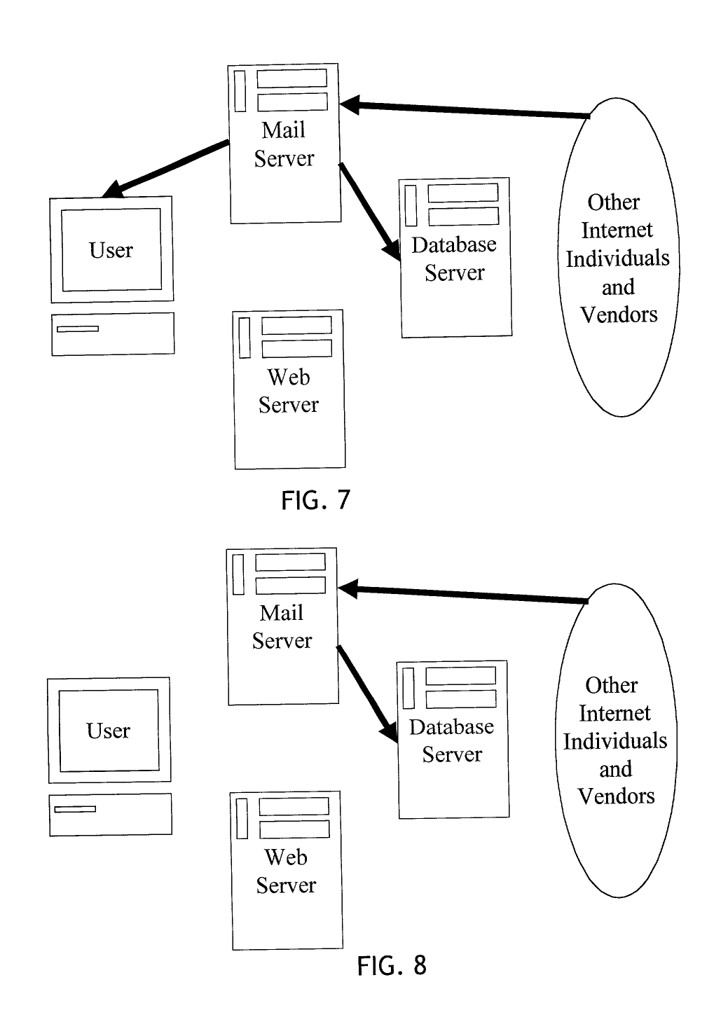

With reference to FIG. 7, the vendor emails the user an order confirmation to the user's Milesmall.com email address. The Milesmall.com mail server receives the email and forwards a copy of it to the user's real email account. In the meantime, the Milesmall system parses the email to determine if it can recognize the purchase information such as: order number, amount purchased and the time of the order. The order information is entered into the transaction table on the database server and the user's account is updated. Alternatively, as shown in FIG. 8, the vendor may send the purchase transaction data directly to the Milesmall system, to be stored in the database. In either case, the system credits the user's account according to the purchase total and the number of points per dollar assigned to the web site.

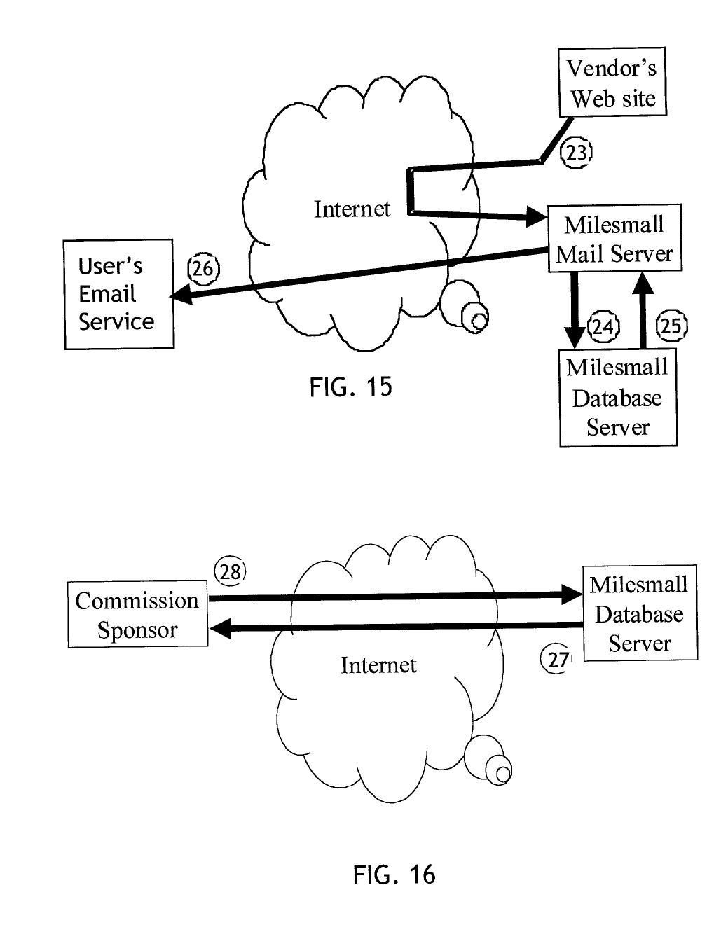

More specifically, as shown in FIG. 15, the vendor sends an email 23 regarding the update to the user's Milesmall.com email account. The mail server takes the email and sends it (24) to the database server for logging and processing. Any purchase metrics are stored and the database is updated. The user's real email account address is sent (25) to the Milesmall mail server. The mail server relays (26) the mail to the real user's email account service.

With regard to FIG. 16, the system may periodically send a request 27 from the database server to download a transaction report from a commission sponsor middleman. The commission sponsor middleman sends the requested report 28, and it is parsed for order information. If an order is found in the database, data for the order is updated on the database server. If the order is not in the database, information about the vendor and user are sent to the database server to be validated. If the information is valid, the order information is added to the database server.

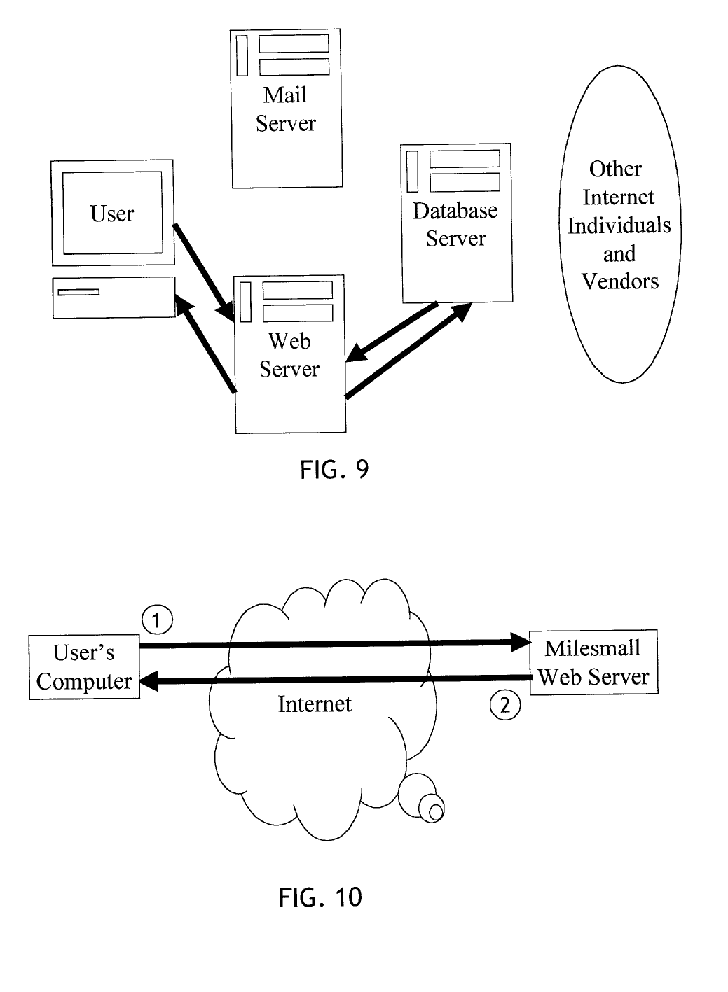

The points awarded for purchases through the Milesmall system are accumulated in the user's account. At any time a registered user may also login to the Milesmall web server, as shown in FIG. 9, and request viewing the account spending history that is stored in the Milesmall database server, and the points that have been awarded and aggregated. This information may be password protected for privacy considerations.

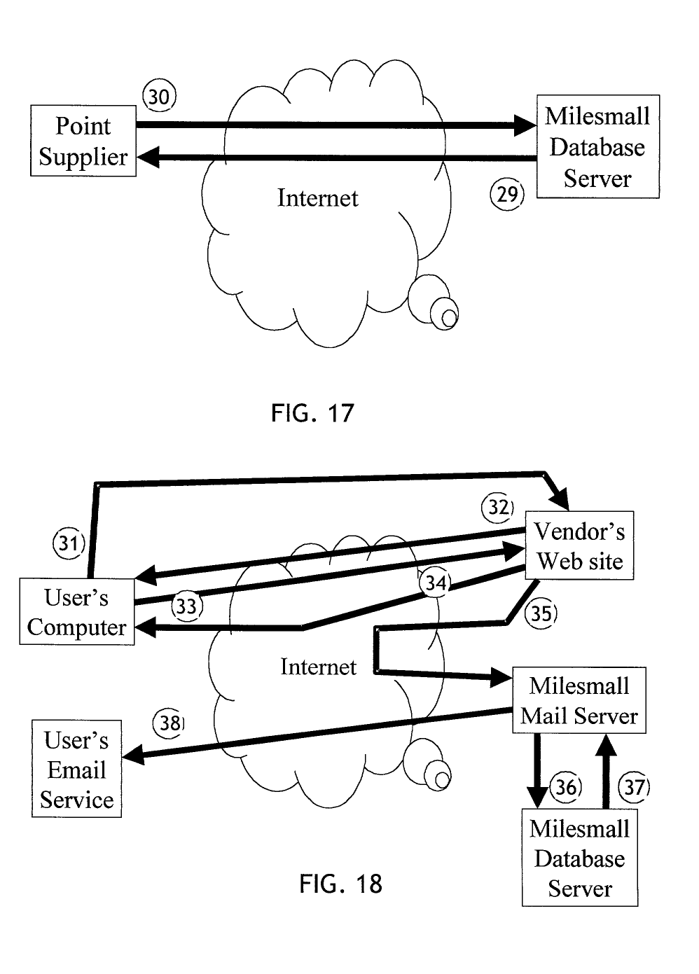

With reference to FIG. 17, the user's account is credited with purchase points in the following manner. Periodically, the database server sends requests 29 to purchases points from a points supplier (airline frequent flier program, hotel points program, etc.) The request includes the individuals involved, program account numbers, and points to be credited. The point purchase request is sent to the points supplier by electronic means (ftp, email, etc.). The point supplier sends a confirmation 30 of the request.

With regard to FIG. 18, a user may occasionally enter a vendor's web site directly, by clicking (31) directly on the vendor's hot link or entering the corresponding URL. The vendor returns the requested web page 32 to the user. All simple page requests and responses may comprise reiteration of the steps 31 and 32. If the user makes a purchase, he or she provides (33) the Milesmall.com email address as his/her email address. Also, when the vendor asks for a Milesmall.com account name, the user provides it. The vendor sends back to the users computer an acknowledgement 34 of an order placed with them, and also sends an email 35 to the user's Milesmall email account, which arrives at the Milesmall.com mail server. The database server takes the email message 36, scans and parses it, and stores any purchase metrics in the database. The database server then returns (37) the real email account corresponding to the Milesmall account name back to the mail server. The Milesmall mail server relays the original mail 38 to the user's email account. Thus purchases that are not initiated through the Milesmall web server may garner purchase points for the registered user.

The points awarded for purchases through the Milesmall system are accumulated in the user's account. At any time a registered user may also login to the Milesmall web server, as shown in FIG. 9, and request viewing the account spending history that is stored in the Milesmall database server, and the points that have been awarded and aggregated. This information may be password protected for privacy considerations.

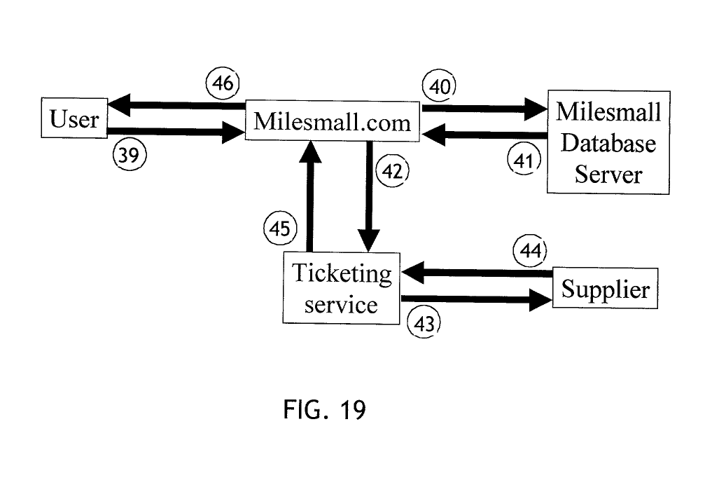

With regard to the detailed view of FIG. 19, when the user elects to redeem Milesmall.com points that are retained in their account (untransferred to a partner reward program), the user contacts (39) Milesmall.com either through the internet or by telephone and provides the desired travel information. (This request may comprise airline service, hotel reservations, car rental, or other accommodation bookings.) The user also provides the reward program associated with the desired travel partner.

Milesmall.com sends a query 40 to the database server to verify that the user has enough stored/accumulated points to make a purchase. The Milesmall database server returns an acknowledgement 41 that there are sufficient points, and the points are deducted from the user account. If there are not enough points, the user is notified (46), and this transaction ends.

Milesmall.com then goes to a travel service (42) to make the purchase of the service on behalf of the user. If the service is unavailable, then the user is notified (46) and this transaction ends. The travel service makes the purchase and associates the purchased service with the user's reward program account information so the user receives miles for that service on the upcoming service. This requires notification 43 to the point supplier for that frequent flier number. The supplier acknowledges (44) the travel service, and the travel service provides the Milesmall.com ticketing information 45 and any billing information for Milesmall.com. Milesmall.com then informs the user of the service details 46 via email or telephone.

It is noted that the user may receive purchase points (in this example, frequent flyer miles) for the redemption transaction. This bonus award, termed herein ‘miles on miles’, provides additional incentive for purchasers to use the Milesmall system.

Thus the present invention provides a broadened purchase award program by eliminating prior art limitations such as use of a specific credit card brand, use of a specific air carrier, purchase of a particular brand of goods, and the like. Any goods or services available by purchase through the internet are capable of being included in this purchase award program, using any valid credit instrument or entity.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A method for providing an on-line purchase award incentive program, including the steps of:
providing a program web site;
accepting user registration with said program and storing the name and email address of each registered user in association with a respective program account;
providing a web page listing a plurality of vendors participating in said program, said web page enabling click-through connection to the web sites of any of said participating vendors;
each registered user electively transacting at least one purchase directly with the web site of one of said participating vendors;
reporting said at least one purchase to said program web site;
crediting the account of the respective registered user with purchase award points according to the dollar amount of said at least one purchase;
reiterating said steps of purchasing, reporting, and crediting to accumulate purchase award points in the respective account of each registered user; and,
each registered user electively redeeming purchase award points in the respective account for goods and/or services.

2. The method for providing an on-line purchase award incentive program of claim 1, further including the step of providing a database server and an email server with said program web site.

3. The method for providing an on-line purchase award incentive program of claim 2, further including the step of storing data concerning registered users associated with email addresses, program accounts, purchases, and award points.

4. The method for providing an on-line purchase award incentive program of claim 1, further including the step of establishing an email address for said program web site.

5. The method for providing an on-line purchase award incentive program of claim 4, wherein each registered user uses said email address of said program web site during each purchase transaction with the web site of one of said participating vendors.

6. The method for providing an on-line purchase award incentive program of claim 5, wherein each purchase transaction of a registered user with the web site of one of said participating vendors is reported via email to said program web site.

7. The method for providing an on-line purchase award incentive program of claim 5, wherein each purchase transaction of a registered user with the web site of one of said participating vendors is first confirmed via an email confirmation to said program web site, and said program web site subsequently sends an email confirmation of the purchase transaction to the registered user.

8. The method for providing an on-line purchase award incentive program of claim 7, wherein said email confirmation to said program web site is parsed to determine purchase data, including at least the dollar amount of purchase.

9. The method for providing an on-line purchase award incentive program of claim 1, wherein said participating vendors may include commission sponsors, and further including the step of periodically sending a request to said commission sponsors for a transaction report of transactions with registered users of said program.

10. The method for providing an on-line purchase award incentive program of claim 9, wherein said transaction report is parsed for data regarding registered users and purchases with participating vendors.

11. The method for providing an on-line purchase award incentive program of claim 1, further including the step of periodically sending a request to purchase points from a points supplier to be credited to the accounts of said registered users of said program.

12. The method for providing an on-line purchase award incentive program of claim 1, wherein the step of redeeming purchase award points includes a registered user requesting an item from said program web site, and said program web site orders said item from a supplier and arranges delivery of said item to the respective registered user.

13. The method for providing an on-line purchase award incentive program of claim 4, wherein a registered user directly contacts and makes a purchase from the web site of a participating vendor, thereafter gives the email address of said program web site to the participating vendor, and said participating vendor reports the purchase to said program web site.

14. The method for providing an on-line purchase award incentive program of claim 1, wherein said purchase step is carried out in accordance with the purchase routine established by the web site of the participating vendor without involvement of said program web site.
